(19) United States
(12) Patent Application Publication
(10) Pub. No.: US 2026/0044748 A1
(43) Pub. Date: Feb. 12, 2026

(54) APPROXIMATION BASED DIGITAL COMPUTING-IN-MEMORY DESIGN SYSTEM USING ARTIFICIAL NEURAL NETWORK AND OPERATION METHOD THEREOF

(71) Applicant: KOREA UNIVERSITY RESEARCH AND BUSINESS FOUNDATION, Seoul (KR)

(72) Inventors: Jongsun Park, Seoul (KR); Kyeong-ho Lee, Seoul (KR); HyeYeong LEE, Seoul (KR)

(21) Appl. No.: 19/271,665

(22) Filed: Jul. 16, 2025

(30) Foreign Application Priority Data
Aug. 8, 2024 (KR) 10-2024-0106178

(51) Int. Cl. G06N 3/126

(52) U.S. Cl. CPC G06N 3/126

(57) ABSTRACT

Disclosed is a method of operating a computing system. The method performed in the computing system having one or more processors and a memory storing one or more programs executed by the one or more processors, includes receiving one of a plurality of artificial neural network architectures as a backbone architecture, determining a structure of a DCIM (Digital Computing-in-Memory) macro based on the backbone architecture, generating an approximate addition candidate group of the DCIM macro based on a first algorithm, generating a heterogeneous approximate DCIM based on the structure of the DCIM macro and the approximate addition candidate group, and mapping channel-specific weights with respect to the heterogeneous approximate DCIM based on a second algorithm.

### CROSS-REFERENCE TO RELATED APPLICATIONS

This application claims priority under 35 U.S.C. § 119 to Korean Patent Application No. 10-2024-0106178 filed on Aug. 8, 2024, in the Korean Intellectual Property Office, the disclosures of which are incorporated by reference herein in their entireties.

### BACKGROUND

Embodiments of the present disclosure described herein relate to an approximation based digital computing-in-memory design system using an artificial neural network and a method of operating the same.

Conventional computer architectures are inefficient since they require a lot of computation and massive data movement to operate an artificial neural network (ANN). To overcome this, a memory technology called Computing-In-Memory is developed that supports existing read/write operations and additionally supports computational functions within the memory. However, there is a problem that hardware costs increase due to the adder tree that has considerable energy and area within the memory.

In addition, in the case of an approximation based digital computing-in-memory for operating an artificial neural network, a trade-off problem occurs between energy, area, and accuracy. Furthermore, there is a problem that the trade-off problem is further exacerbated in the memory structure at the memory cell array level.

### SUMMARY

Embodiments of the present disclosure provide an approximation based digital computing-in-memory design system using an artificial neural network and a method of operating the same.

According to an embodiment of the present disclosure, a method performed in the computing system having one or more processors and a memory storing one or more programs executed by the one or more processors, includes receiving one of a plurality of artificial neural network architectures as a backbone architecture, determining a structure of a DCIM (Digital Computing-in-Memory) macro based on the backbone architecture, generating an approximate addition candidate group of the DCIM macro based on a first algorithm, generating a heterogeneous approximate DCIM based on the structure of the DCIM macro and the approximate addition candidate group, and mapping channel-specific weights with respect to the heterogeneous approximate DCIM based on a second algorithm.

According to an embodiment, the generating of the approximate addition candidate group may include performing a partitioned approximate addition on quantized bits to generate a bit group and determining a gene of the bit group.

According to an embodiment, the generating of the approximate addition candidate group may include using an evolutionary algorithm as the first algorithm, and generating the approximate addition candidate group by mutating and crossovering the gene.

According to an embodiment, the mapping of the channel-specific weights may include using a genetic algorithm as the second algorithm.

According to an embodiment, the receiving of the one of the plurality of artificial neural network architectures as the backbone architecture may include receiving quantized bits of inputs and weights of the backbone architecture, a fitness of the backbone architecture, and a target value of the computing system as input data.

According to an embodiment of the present disclosure, a computing system includes an input module that receives one of a plurality of artificial neural network architectures as a backbone architecture, a DCIM structure module that determines a structure of a DCIM (Digital Computing-in-Memory) macro based on the backbone architecture, a computation module that generates an approximate addition candidate group of the DCIM macro based on a first algorithm, a synthesis module that generates a heterogeneous approximate DCIM based on the structure of the DCIM macro and the approximate addition candidate group, and a mapping module that maps channel-specific weights with respect to the heterogeneous approximate DCIM based on a second algorithm.

According to an embodiment, the computation module may perform a partitioned approximate addition on quantized bits to generate a bit group and may determine a gene of the bit group.

According to an embodiment, the display module may use an evolutionary algorithm as the first algorithm, and may generate the approximate addition candidate group by mutating and crossovering the gene.

According to an embodiment, the mapping module may use a genetic algorithm as the second algorithm.

According to an embodiment, the input module may receive quantized bits of inputs and weights of the backbone architecture, a fitness of the backbone architecture, and a target value of the computing system as input data.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a computing system, according to some embodiments of the present disclosure.

FIG. 2 is a diagram for describing a partitioned approximate addition, according to some embodiments.

FIG. 3 is a diagram for describing an evolutionary algorithm-based approximation search, according to some embodiments.

FIG. 4 is a diagram for describing a heterogeneous approximate DCIM, according to some embodiments.

FIGS. 5A and 5B are diagrams for describing a genetic algorithm-based channel-specific mapping, according to some embodiments.

FIG. 6 is a diagram illustrating an operation sequence of a processor, according to some embodiments of the present disclosure.

FIG. 7 is a diagram illustrating an operation sequence of a computation module, according to some embodiments of the present disclosure.

FIG. 8 illustrates a memory device, according to some embodiments.

FIG. 9 illustrates an artificial intelligence execution operation of a heterogeneous approximate DCIM, according to some embodiments.

### DETAILED DESCRIPTION

Hereinafter, embodiments of the present disclosure will be described in detail and clearly to such an extent that an ordinary one in the art easily implements the present disclosure.

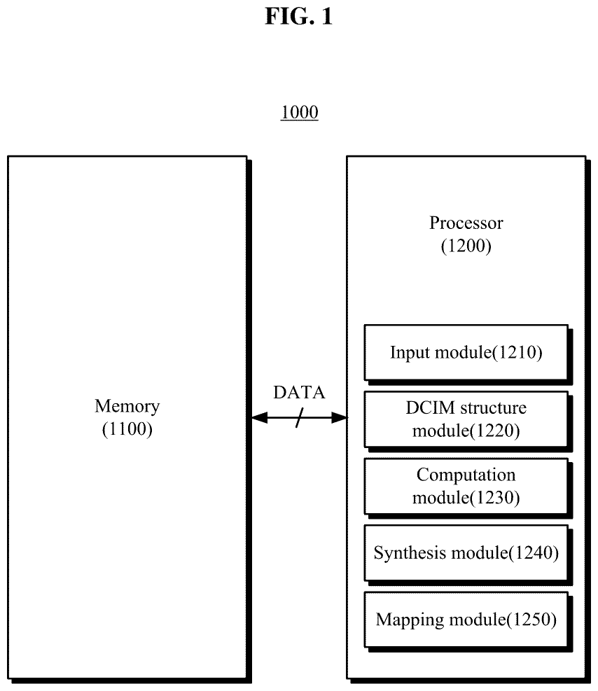

FIG. 1 is a block diagram illustrating a computing system, according to some embodiments of the present disclosure.

Referring to FIG. 1, a computing system 1000 according to some embodiments may function as a computing device for designing a digital computing-in-memory (DCIM). To this end, the computing system 1000 may include a memory 1100 and a processor 1200.

The memory 1100 may be a storage device that stores one or more programs executed by one or more processors. The memory 1100 may store a program for executing operations of the processors or operations of each configuration of the processors. In this case, the memory 1100 may be implemented as a solid state drive (SD), an embedded universal flash storage (UFS), an embedded multi-media card (eMMC), a compact flash (CF), a secure digital (SD), a micro-SD (MicroSecure Digital), a mini-SD (Mini Secure Digital), an extreme digital (xD), or a memory stick.

The processor 1200 may operate to design the DCIM by executing a program stored in the memory 1100. To this end, the processor 1200 may include an input module 1210, a DCIM structure module 1220, a computation module 1230, a synthesis module 1240, and a mapping module 1250.

The input module 1210 may receive one of a plurality of artificial neural networks (ANNs) as a backbone architecture. The input module 1210 may provide input data to one of the artificial neural networks and may allow the input data to be trained through computations such as a convolution. In this case, the artificial neural network may be an artificial neural network such as a deep neural network (DNN), a convolutional neural network (CNN), a recurrent neural network (RNN), or a deep belief network (DBN). The embodiments of the present disclosure will be described primarily with reference to the deep neural network (DNN) as the artificial neural network, but the embodiments of the present disclosure are not limited thereto.

The input module 1210 may receive input data from the memory 1100. In this case, the input data may be quantized bits of inputs and weights of the backbone architecture for a DCIM design of the computing system 1000, a fitness of the backbone architecture, and a design budget (e.g., accuracy/area constraints) of the computing system 1000.

The DCIM structure module 1220 may determine a structure of the DCIM macro based on the backbone architecture. The DCIM macro is a basic architecture of a memory device and may be a DCIM macro including a plurality of memory cells. In this case, the plurality of memory cells may be volatile memory cells such as an SRAM (Static Random Access Memory), a DRAM (Dynamic Random Access Memory), etc. In addition, in some embodiments, the plurality of memory cells included in the memory 1100 may be non-volatile memory cells such as flash memory cells, RRAM (Resistive Random Access Memory) cells, etc. Example embodiments of the present disclosure will be described primarily with reference to the SRAM cell, but the embodiments of the present disclosure are not limited thereto.

The computation module 1230 may perform a partitioned approximate addition on the quantized bits received from the input module 1210. In this case, the partitioned approximate addition may be a two-part addition that divides the entire bits into two bit groups and performs the computation.

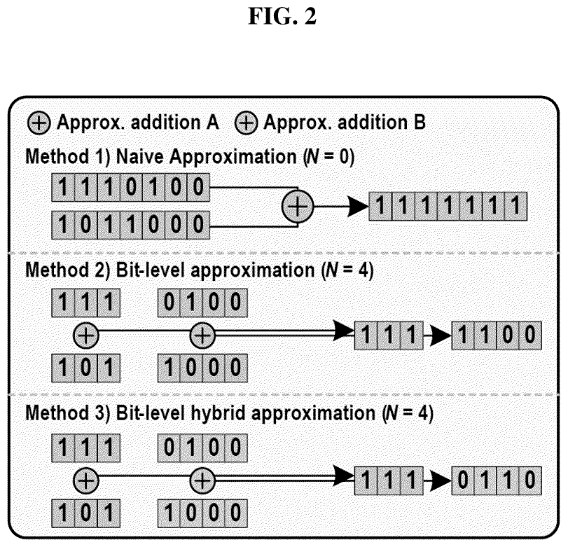

In addition, the computation module 1230 may apply a first algorithm to the partitioned bits to generate an approximate addition candidate group of the DCIM macro. In this case, the first algorithm may be an Evolutionary Algorithm-based Approximation Search (EAAS). For example, the computation module 1230 may perform an approximate addition on the quantized bits into one or two bit groups. A more detailed description will be described later in FIG. 2.

The synthesis module 1240 may generate a heterogeneous approximate DCIM that satisfies the target value based on the structure of the DCIM macro and the approximate addition candidate group. According to some embodiments, the synthesis module 1240 may include a plurality of local arrays corresponding to the approximate addition candidates. The plurality of local arrays may include an approximate adder in which one of the approximate addition candidates is stored as a weight.

The mapping module 1250 may map channel-specific weights with respect to the heterogeneous approximate DCIM based on a second algorithm. In this case, the second algorithm may be a genetic algorithm (GA). The mapping module 1250 according to some embodiments may evaluate the fitness of the approximate addition candidates and may perform an evaluation for each approximation method. In this case, the fitness may be a fitness of the backbone architecture received from the input module 1210.

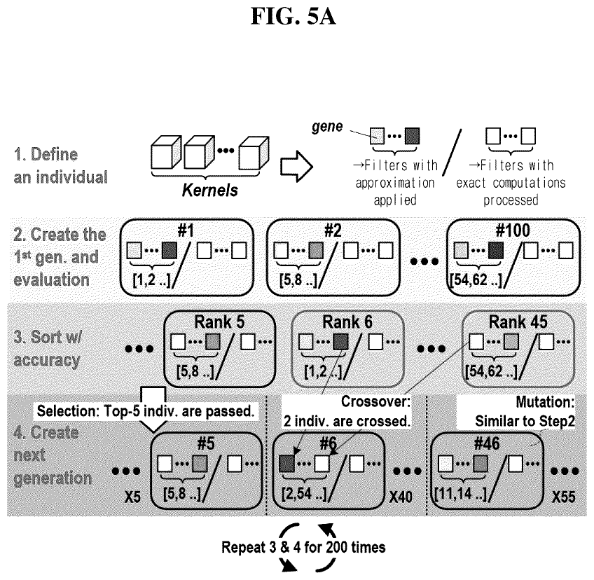

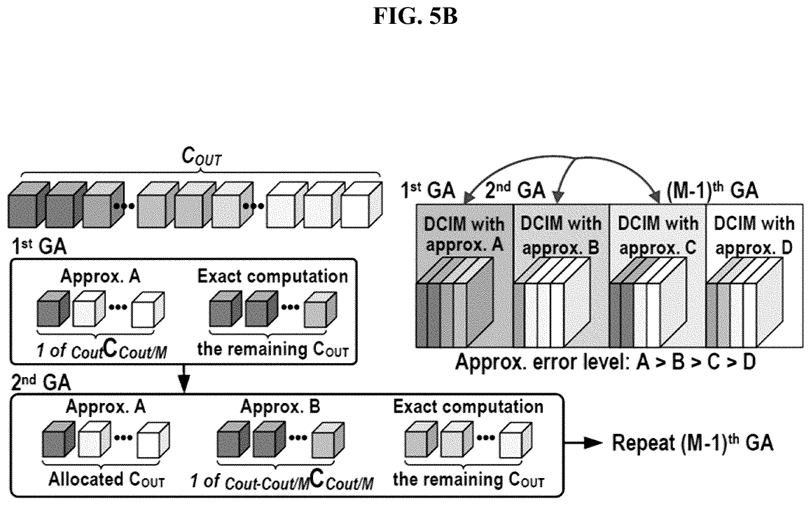

Accordingly, the mapping module 1250 may first perform a computation on an approximate addition with the largest error by dividing the output channel by the number of DCIM macros, and may process the remaining channels with accurate calculations. A more detailed description will be described later in FIG. 5A and FIG. 5B.

As described above, the computing system 1000 according to some embodiments of the present disclosure may design a DCIM structure suitable for a deep neural network by using an evolutionary algorithm-based approximate search and a genetic algorithm. In detail, the computing system 1000 may efficiently search for a wide design space consisting of bit-level approximates and may reduce the trade-off problem between hardware cost and accuracy by appropriately mapping channel-specific weights.

FIG. 2 is a diagram for describing a partitioned approximate addition, according to some embodiments.

Referring to FIG. 2, the computation module 1230 may perform a partitioned approximate addition by dividing the quantized bits into one or two bit groups.

For example, when there is one bit group, the computation module 1230 may perform a partitioned approximate addition on seven bits to generate approximate addition candidates. In addition, when there are two bit groups and the group size “N” of a Least Significant Bit (LSB) group is “4”, the computation module 1230 may generate three Most Significant Bit (MSB) groups and four Least Significant Bit groups. Accordingly, the computation module 1230 may generate approximate addition candidates of 3 bits and 4 bits, respectively. In this case, the computation module 1230 may perform the approximate addition with bits corresponding to the group size “N”. In addition, the computation module 1230 may perform a hybrid approximate addition with bits corresponding to the group size “N”.

As described above, the computation module 1230 according to some embodiments may expand the approximate space of approximate addition candidates.

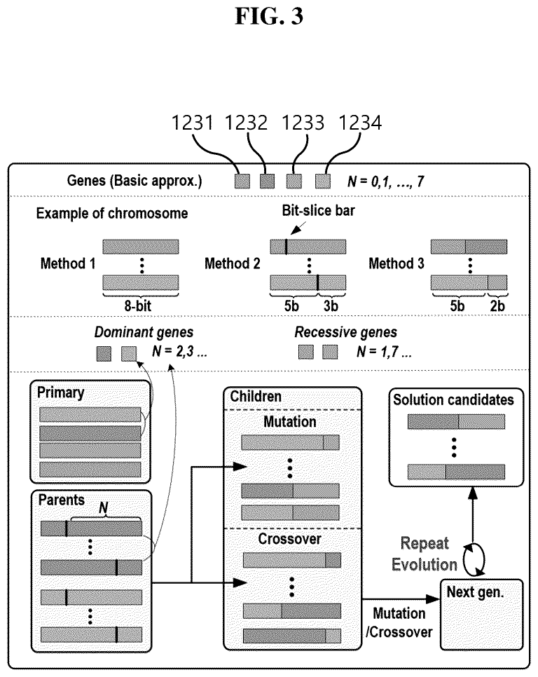

FIG. 3 is a diagram for describing an evolutionary algorithm-based approximation search, according to some embodiments.

The number “M” of DCIM macros below will be described as “4”, and the corresponding approximate addition method will be expressed as 4 genes 1231, 1232, 1233, and 1234. In addition, a bit group will be divided using a bit slice bar to express the approximate. However, this is only an example for the convenience of description and is not limited thereto.

Referring to FIG. 3, the computation module 1230 may search for genes 1231, 1232, 1233, and 1234 that satisfy the fitness of the backbone architecture received from the input module 1210 by performing an approximate search based on an evolutionary algorithm on the partitioned bits.

The computation module 1230 according to some embodiments may include multiple approximate addition methods that perform partitioned approximate addition on four genes 1231, 1232, 1233, and 1234.

The computation module 1230 may determine an approximate addition method implemented with homogeneous genes 1231, 1232, 1233, and 1234 without bit slice bars as an initial candidate group. The homogeneous genes 1231, 1232, 1233, and 1234 selected as the initial candidate group may be evaluated for fitness and may be either survived or excluded. For example, a gene that falls below half of a fitness criterion may be excluded. When the first and fourth genes 1231 and 1234 satisfy the fitness, the computation module 1230 may determine the first and fourth genes 1231 and 1234) as dominant genes and may determine the second and third genes 1232 and 1233 as recessive genes. However, this is only an example and is not limited thereto.

The computation module 1230 may repeat mutation and crossover based on the first and fourth genes 1231 and 1234. That is, the surviving genes may be classified as the first generation genes of the evolution algorithm, and the first generation genes may be mutated and crossovered to generate the second generation genes. In this case, the surviving genes may be mutated and crossovered with the excluded genes to generate the second generation genes. In this case, when the surviving genes are crossovered with the excluded genes, the positions of the bit slide bars may be maintained.

As described above, the computation module 1230 according to some embodiments of the present disclosure may evolve the genes “N” times to satisfy the fitness of the artificial neural network. Accordingly, the computation module 1230 may search for an approximation method that satisfies the fitness in a vast approximation space resulting from the partitioned approximate addition.

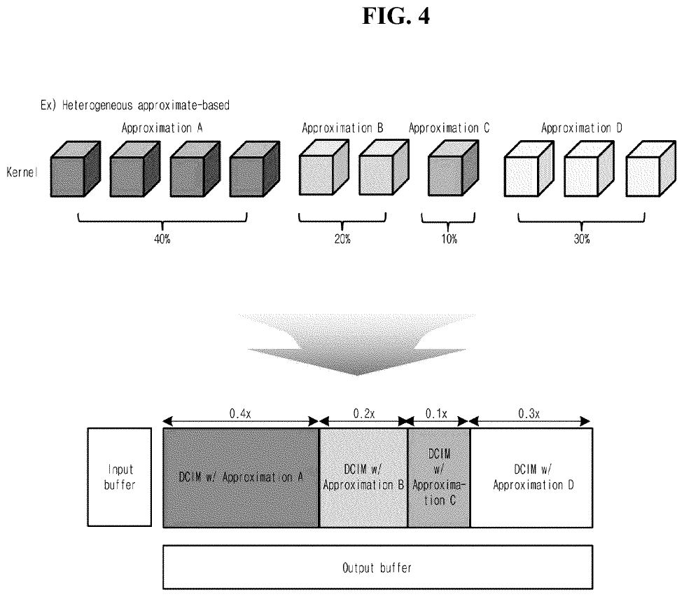

FIG. 4 is a diagram for describing a heterogeneous approximate DCIM, according to some embodiments.

Referring to FIG. 4, the synthesis module 1240 may generate a heterogeneous approximate DCIM satisfying a target value based on the structure of the DCIM macro and the approximate addition candidate group. The heterogeneous approximate DCIM may include a plurality of memory cells that use the approximate addition candidate group as a weight of an adder. That is, the synthesis module 1240 may satisfy the design budget (e.g., accuracy/area constraints) by using the approximate addition candidate group to which the evolutionary algorithm-based approximate search is applied as a weight of the adder.

FIGS. 5A and 5B are diagrams for describing a channel-specific mapping, according to some embodiments. The following limitations are only examples for describing the present disclosure and are not limited thereto.

Referring to FIG. 5A, the channel-specific mapping step may be divided into steps 1 to 4.

In the first step, the processor 1200 may define the output channel assigned to the approximation as a genetic expression.

In the second step, the processor 1200 may generate an initial population including a plurality of individuals for each convolutional layer. In this case, the initial population may be a bit group.

For example, the processor 1200 may generate an initial population including 100 individuals for each convolutional layer for the output channel assigned to the approximation.

In the third step, the processor 1200 may evaluate the suitability of the initial population through accuracy simulation. That is, the third step may be a step of determining the genes of the bit group.

In addition, the processor 1200 may generate a ranking of the initial population based on the suitability evaluation, and may select the initial population based on the preset criteria. For example, the processor 1200 may generate a ranking by evaluating the suitability of 100 individuals, and may select 40 individuals based on the preset criteria. In this case, the suitability evaluation may be a criterion with the least loss.

In the fourth step, the processor 1200 may generate the next generation through selection, crossover, and random generation. In this case, the selection may be a method in which the genetic expression of the top 5 individuals is preserved and passed on to the next generation.

The crossover may be a method in which two individuals are selected from the 40 surviving individuals, and genetic information is extracted from the two selected individuals to generate new individuals. In addition, in the crossover method, 40 individuals may be newly generated for the next generation.

The random generation may be a method in which 55 individuals are randomly selected other than selection and crossover. Thereafter, the processor 1200 may repeat steps 1 to 4 to consider the individual with the smallest loss as the solution of the approximation (i.e., the mapping strategy between the channel and the approximation).

Referring to FIG. 5B, the mapping module 1250 may perform channel-specific mapping with respect to the heterogeneous approximation DCIM based on a genetic algorithm. In more detail, the mapping module 1250 may map an approximation to each output channel C_{OUT} through the genetic algorithm. The mapping module 1250 may input the previous output value to the next genetic algorithm between each iteration of the genetic algorithm. In case the accuracy loss constraint is not satisfied, the algorithm may be preferentially executed when the approximation error is larger to terminate the candidate generation early.

For example, when the number of output channels C_{OUT} is 16 and the number “M” of DCIM macros is 4, the mapping module 1250 may map a first approximate addition candidate group with the largest error to a first output channel through the genetic algorithm. In addition, the mapping module 1250 may map a second approximate addition candidate group with the largest error, excluding the first approximate addition candidate group, to the second output channel through the genetic algorithm. That is, the mapping module 1250 may map the approximate addition candidate group to all output channels C_{OUT} in order of error size by repeating the genetic algorithm M-1 times.

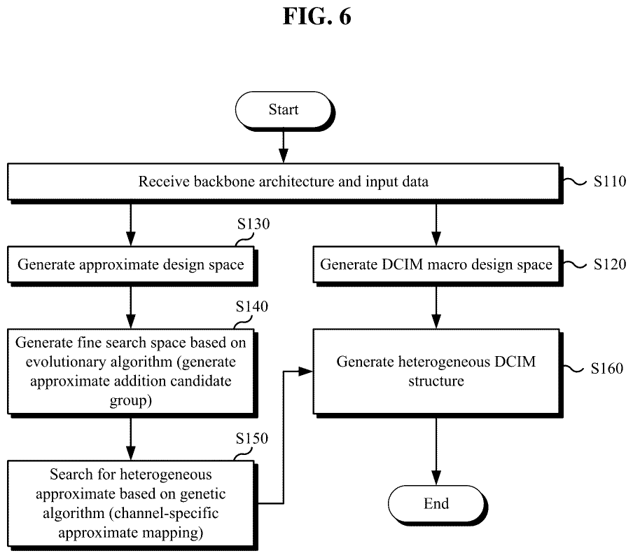

FIG. 6 is a diagram illustrating an operation sequence of a processor, according to some embodiments of the present disclosure.

Referring to FIG. 6, in operation S110, the input module 1210 may receive one of the plurality of artificial neural networks as a backbone architecture. In addition, the input module 1210 may receive quantized bits inputs and weights of the backbone architecture, fitness, and design budget (e.g., accuracy/area constraints) for the DCIM design as input data.

In operation S120, the DCIM structure module 1220 may determine the structure of the DCIM macro based on the backbone architecture. According to some embodiments, the DCIM structure module 1220 may determine the DCIM macro structure of the SRAM structure.

In operation S130, the computation module 1230 may perform a partitioned approximate addition on the quantized bits.

In operation S140, the computation module 1230 may perform an evolutionary algorithm-based approximate search on the bits partitioned by the partitioned approximate addition to generate approximate addition candidate groups.

In operation S150, the mapping module 1250 may approximate map channel-specific weights with respect to the heterogeneous approximate DCIM based on the genetic algorithm.

In operation S160, the synthesis module 1240 may generate a heterogeneous approximate DCIM that satisfies the design budget based on the structure of the DCIM macro and the approximate mapping. For example, the heterogeneous approximate DCIM may be a memory cell array including a plurality of local arrays.

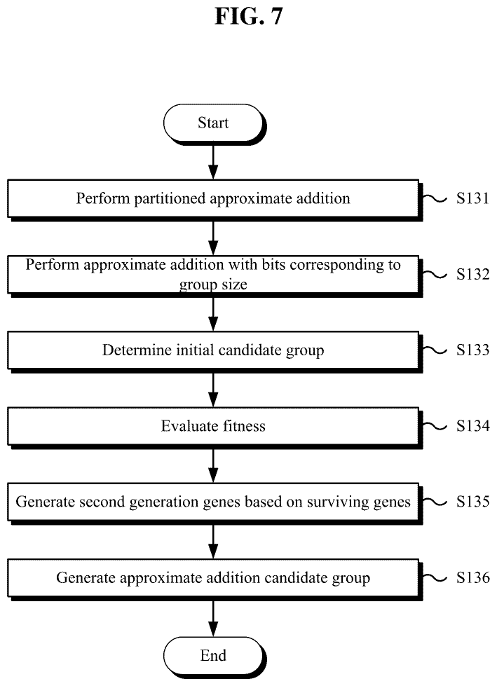

FIG. 7 is a diagram illustrating an operation sequence of a computation module, according to some embodiments of the present disclosure.

In operation S131, the computation module 1230 may perform a partitioned approximate addition by dividing the quantized bits into one or two bit groups. For example, the computation module 1230 may divide the most significant bit group and the least significant bit group based on the group size “N” of the least significant bit group.

In operation S132, the computation module 1230 may perform approximate addition with bits corresponding to the group size “N”. In addition, the computation module 1230 may perform a hybrid approximate addition with bits corresponding to the group size “N”.

In operation S133, the computation module 1230 may determine an approximate addition method implemented with homogeneous genes without bit slice bars as an initial candidate group.

In operation S134, the computation module 1230 may evaluate the fitness of each homogeneous gene selected as an initial candidate group. For example, genes with a fitness decrease of less than 1% may be excluded.

In operation S135, the computation module 1230 may generate second generation genes by repeating mutation and crossover based on the surviving genes. In this case, the surviving genes may be mutated and crossovered with the excluded genes.

In operation S136, the computation module 1230 may perform a fitness evaluation on the second generation genes to generate an approximate addition candidate group.

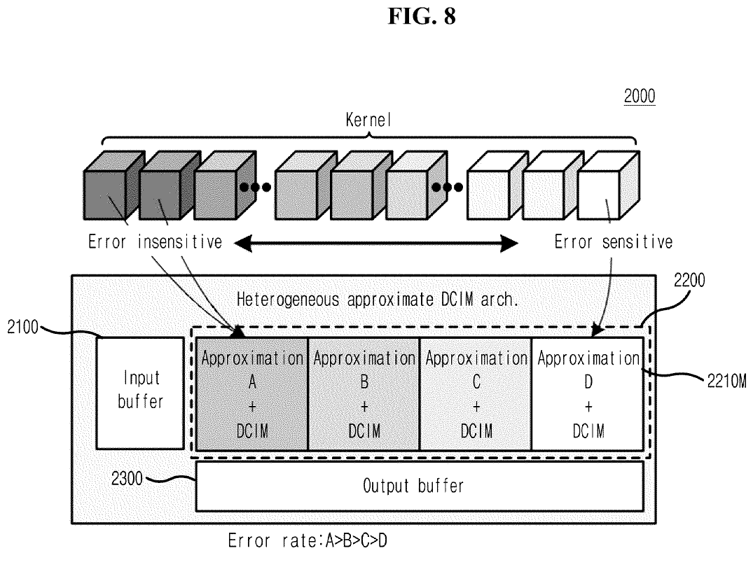

FIG. 8 illustrates a memory device, according to some example embodiments.

Referring to FIG. 8, a memory device 2000 according to some embodiments may function as a computing device for performing the digital computing-in-memory (DCIM). To this end, the memory device 2000 may include an input buffer 2100, a memory sub-array 2200, and an output buffer 2300.

The input buffer 2100 may store input data received from external circuits (e.g., a main memory). In this case, the input data may be an artificial neural network for computing of the memory device 2000, input/weight quantization bits, a fitness of a neural network model, and a target value of the computing system 1000. The input buffer 2100 may be connected to each of heterogeneous approximation DCIMs 2210_1 to 2210_M within the memory sub-array 2200 to provide input data.

The memory sub-array 2200 may include the heterogeneous approximate DCIMs 2210_1 to 2210_M composed of a plurality of columns. In some embodiments, each of the heterogeneous approximate DCIMs 2210_1 to 2210_M may be an SRAM macro.

In an SRAM device, data may be written to and read from each SRAM cell via one or more bit lines “BL” upon activation of one or more access transistors within the SRAM cell by enabling signals from one or more word lines “WL”.

The heterogeneous approximate DCIMs 2210_1 to 2210_M may be DCIM devices configured to perform various digital computing-in-memory computations, such as multiply-accumulate (MAC) computations.

The MAC computations may be primary computations used at the chip level for training and computing neural networks in an artificial intelligence (AI). In some AI systems, such as artificial neural networks, a data array may be weighted by a plurality of weight columns. The weighting by each weight column may generate a respective output sum. Accordingly, the AI system may include a memory cell that performs the MAC computation of the weights within the matrix of the input data array and a plurality of weight columns. In addition, the AI system may map the input to the output based on the set of weights.

The output buffer 2300 may communicate with external circuits (e.g., a main memory) and may transfer the final computed output to the external circuits.

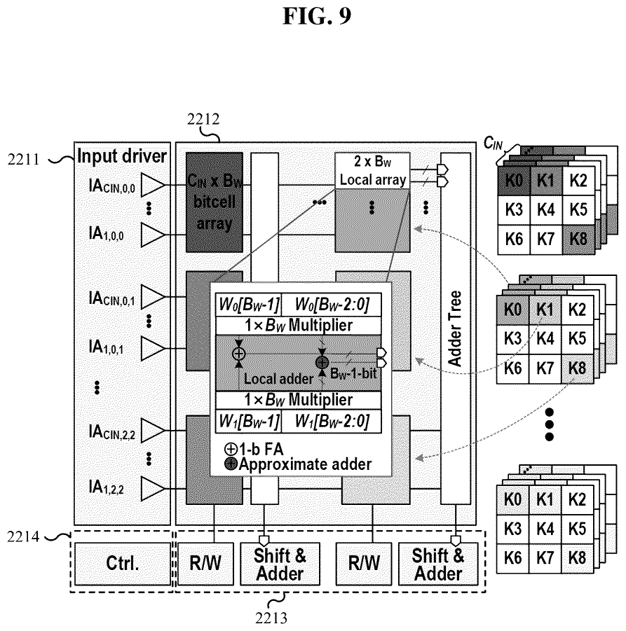

FIG. 9 illustrates a heterogeneous approximation DCIM, according to some embodiments.

Referring to FIG. 9, the heterogeneous approximation DCIM 2210_M according to some embodiments may include an input driver 2211, a memory cell array 2212, and a peripheral circuit 2213.

The input driver 2211 is connected to the memory cell array 2212 through a plurality of word lines, and may activate one word line among the plurality of word lines based on a row address. In this case, the input driver 2211 may transfer an input value IA_{CIN} to each memory cell through the plurality of word lines.

The memory cell array 2212 may include a plurality of local arrays, and may include an adder tree corresponding to the column lines of the plurality of local arrays. In this case, each local array may map a weight for each channel by using an approximate addition candidate group as a weight. The adder tree may add and output output signals from the local array on each column.

The peripheral circuit 2213 is connected to the memory cell array 2212 through a plurality of bit lines, and may activate a pair of bit lines among the plurality of bit lines based on a column address. The peripheral circuit 2213 may read values stored in memory cells corresponding to the activated word lines by activating a pair of bit lines during a read operation and sensing current and/or voltage received through the pair of bit lines. In addition, the peripheral circuit 2213 may apply current and/or voltage to a pair of bit lines based on data to be written during a write operation.

A control circuit 2214 may receive a command CMD and may control the input driver 2211 and the peripheral circuit 2213 based on the received command CMD. For example, the control circuit 2214 may identify a read command or a write command by decoding the command CMD and may generate a control signal to perform the identified operation. The control circuit 2214 may activate or deactivate the plurality of word lines and/or bit lines at timings determined based on the control signal.

According to an embodiment of the present disclosure, the approximation based digital computing-in-memory design system using an artificial neural network may efficiently search for a wide design space with bit-level approximations, and may reduce the trade-off between hardware cost and accuracy by mapping channel-specific weights.

The above descriptions are specific embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A method performed in a computing system having one or more processors and a memory storing one or more programs executed by the one or more processors, the method comprising:
receiving one of a plurality of artificial neural network architectures as a backbone architecture;
determining a structure of a DCIM (Digital Computing-in-Memory) macro based on the backbone architecture;
generating an approximate addition candidate group of the DCIM macro based on a first algorithm;
generating a heterogeneous approximate DCIM based on the structure of the DCIM macro and the approximate addition candidate group; and
mapping channel-specific weights with respect to the heterogeneous approximate DCIM based on a second algorithm.

2. The method of claim 1, wherein the generating of the approximate addition candidate group includes performing a partitioned approximate addition on quantized bits to generate a bit group and determining a gene of the bit group.

3. The method of claim 2, wherein the generating of the approximate addition candidate group includes using an evolutionary algorithm as the first algorithm, and generating the approximate addition candidate group by mutating and crossovering the gene.

4. The method of claim 1, wherein the mapping of the channel-specific weights includes using a genetic algorithm as the second algorithm.

5. The method of claim 1, wherein the receiving of the one of the plurality of artificial neural network architectures as the backbone architecture includes receiving quantized bits of inputs and weights of the backbone architecture, a fitness of the backbone architecture, and a target value of the computing system as input data.

6. A computing system comprising:
an input module configured to receive one of a plurality of artificial neural network architectures as a backbone architecture;
a DCIM structure module configured to determine a structure of a DCIM (Digital Computing-in-Memory) macro based on the backbone architecture;
a computation module configured to generate an approximate addition candidate group of the DCIM macro based on a first algorithm;
a synthesis module configured to generate a heterogeneous approximate DCIM based on the structure of the DCIM macro and the approximate addition candidate group; and
a mapping module configured to map channel-specific weights with respect to the heterogeneous approximate DCIM based on a second algorithm.

7. The computing system of claim 6, wherein the computation module performs a partitioned approximate addition on quantized bits to generate a bit group and determines a gene of the bit group.

8. The computing system of claim 7, wherein the display module uses an evolutionary algorithm as the first algorithm, and generates the approximate addition candidate group by mutating and crossovering the gene.

9. The computing system of claim 6, wherein the mapping module uses a genetic algorithm as the second algorithm.

10. The computing system of claim 6, wherein the input module receives quantized bits of inputs and weights of the backbone architecture, a fitness of the backbone architecture, and a target value of the computing system as input data.
